(19) United States
(12) Patent Application Publication
(10) Pub. No.: US 2026/0073073 A1
(43) Pub. Date: Mar. 12, 2026

(54) METHOD AND CREDENTIAL FOR CONSENT-BASED ANALYSIS OF MOBILE WALLET DATA

(71) Applicant: AffinitiQuest.io, Kanata (CA)

(72) Inventor: Ben PIERCEY, Richmond (CA)

(21) Appl. No.: 19/105,645

(22) PCT Filed: Aug. 23, 2023
(86) PCT No.: PCT/CA2023/051116

§ 371 Date: Feb. 21, 2025

Related U.S. Application Data
(60) Provisional application No. 63/400,103, filed on Aug. 23, 2022.

(51) Int. Cl. G06F 21/62

(52) U.S. Cl. CPC G06F 21/6245

(57) ABSTRACT

Analysis credential for analyzing contents of a user's mobile/identity wallet and a method for doing same. An analysis credential is designed by an issuer and provided to a user's computing device at the user's active request. Instructions relating to the analysis credential cause a search of the wallet contents for relevant items and cause a value for the credential to be computed based on the contents of the wallet. The user is then prompted to provide consent for sharing the value of the credential with a verifier. The value of the credential preferably contains no identifying or sensitive information about the user. The analysis credential, in some embodiments, is evaluated on a predetermined schedule, while in other embodiments, the analysis credential is only evaluated in response to the user's request. Consent to evaluate the analysis credential may also be required in some embodiments.

### TECHNICAL FIELD

The present invention relates to mobile wallets. More specifically, the present invention relates to privacy and consent-based methods for analyzing mobile wallet contents.

### BACKGROUND

The growth of the Internet and related technologies in recent years has led to the exponential growth in the collection and use of data. Moreover, data related to individual consumers can be extremely useful for retailers, producers, and other organizations. Such data allow these organizations to provide customized experiences, rewards, and benefits based on the individual consumer's needs, preferences and/or interests indicated by such data. However, concerns around data protection and privacy, as well as difficulties and expenses related to storing such data, have also risen commensurately. Various techniques and systems, including decentralized identity techniques using digital/mobile wallets, have been developed to address such concerns and to provide more flexibility to users.

As more organizations begin to adopt such technologies, mobile and digital wallets residing in browser extension applications and mobile applications will represent an expanding set of repositories containing value consumer trend data. However, by providing users with greater control and flexibility, such systems will result in challenges across other industries. Specifically, existing data analysis technology ecosystems which are presently directed to marketing and advertising efficiency will face challenges in the amount and quality of data at their disposal.

Currently, wallet applications may provide software that performs periodic searches and computations on the search results using well-known techniques. The wallet application may or may not seek user consent to perform such analyses and may or may not enshrine user consent into their terms and conditions. Furthermore, the outcomes of such analyses may contain personally identifying or other sensitive information and is typically delivered off-device to a centralized repository where it is no longer controlled by the end-user. Thus, while traditional analysis methods can be used to analyze consumer data that happens to reside in a digital wallet, this approach perpetuates flaws that allow for unscrupulous data mining and that led to the development of decentralized identity and verifiable credentials in the first place.

As such, there is a need for data structures and analysis methods for a mobile wallet context that provides analytical data to marketers while preserving privacy and data control for the individual consumer.

### SUMMARY

This document discloses an analysis credential for analyzing contents of a user's mobile/identity wallet and a method for such analysis. An analysis credential is designed by an issuer and provided to a user's computing device at the user's active request. Instructions relating to the analysis credential cause a search of the wallet contents for relevant items and cause a value for the credential to be computed based on the contents of the wallet. The user is then prompted to provide consent for sharing the value of the credential with a verifier. The value of the credential preferably contains no identifying or sensitive information about the user. The analysis credential, in some embodiments, is evaluated on a predetermined schedule, while in other embodiments, the analysis credential is only evaluated in response to the user's request. Consent to evaluate the analysis credential may also be required in some embodiments.

In a first aspect, this document discloses a method for analyzing mobile wallet contents, the method comprising the steps of: receiving a prompt for consent to deliver an analysis credential to a mobile wallet, said mobile wallet containing a plurality of items; receiving said consent from a user of said mobile wallet; after said consent is received, receiving said analysis credential at said mobile wallet; and executing instructions relating to said analysis credential to thereby determine a value for said analysis credential, said value being based on at least a subset of said plurality of items, wherein said mobile wallet is operated on a computing device used by said user.

In another embodiment, this document discloses a method further comprising the step of providing said value to a verifier of said analysis credential for verification.

In another embodiment, this document discloses a method wherein a second consent is requested from said user before providing said value to said verifier.

In another embodiment, this document discloses a method wherein the consent is received by way of a specific physical action of said user.

In another embodiment, this document discloses a method wherein executing said instructions comprises: searching said mobile wallet for items that meet at least one criterion, said at least one criterion being described in said analysis credential; when an item is determined to meet said at least one criterion, said item is added to said subset; and computing an item value for each item in said subset, based on instructions in said analysis credential.

In another embodiment, this document discloses a method wherein said value is based on item values for all items in the subset.

In another embodiment, this document discloses a method wherein said instructions are comprised in at least one of: said analysis credential and said mobile wallet.

In another embodiment, this document discloses a method wherein said value is a numerical value.

In another embodiment, this document discloses a method wherein said value is determined by applying at least one function to said item values.

In another embodiment, this document discloses a method wherein said at least one function comprises at least one of: a count; a sum; an average; a minimum-determining function; a maximum-determining function; a variance-determining function; and a standard deviation function.

In another embodiment, this document discloses a method wherein, based on said value, said verifier determines whether said analysis credential is satisfied.

In another embodiment, this document discloses a method wherein, when said analysis credential is satisfied, said verifier provides a first result to said computing device and, when said analysis credential is unsatisfied, said verifier provides a second result to said computing device.

In another embodiment, this document discloses a method wherein said value is determined at a prescheduled time.

In another embodiment, this document discloses a method wherein said value is determined at predetermined intervals.

In another embodiment, this document discloses a method wherein said value is determined responsive to a request by said user.

In another embodiment, this document discloses a method wherein said verifier determines whether said analysis credential is satisfied based on communication with an issuer of said analysis credential.

In another embodiment, this document discloses a method wherein said value is unassociated with personally identifiable information of said user.

In a second aspect, this document discloses a credential for a mobile wallet used by a user, said credential being a data file for use in analyzing contents of said mobile wallet, wherein said credential is visible to said user wherein consent of said user is required for any analysis involving said credential, and wherein said contents of said mobile wallet are analyzed to thereby produce a value for said credential, said value being for comparison with said expected value.

In another embodiment, this document discloses a credential wherein said data file comprises at least one of: instructions for analyzing said contents, and other instructions to direct an application relating to said mobile wallet to analyze said content.

In another embodiment, this document discloses a credential wherein said instructions are executed responsive to a request from said user.

In another embodiment, this document discloses a credential wherein said instructions are only executed after a valid request from said user.

In another embodiment, this document discloses a credential wherein, when said value is computed, said user is automatically prompted to provide consent for sending said value to a verifier of said credential, and, when said consent is received, said value is automatically sent to said verifier.

### BRIEF DESCRIPTION OF THE DRAWINGS

The present invention will now be described by reference to the following figures, in which identical reference numerals refer to identical elements and in which:

FIG. 1 is a schematic diagram of a system for implementing the invention;

FIG. 2A is an exemplary interface for a credential according to an aspect of the invention;

FIG. 2B is another exemplary interface for the credential of FIG. 2A;

FIG. 3 is a schematic process diagram for delivering an analysis credential to a user's device;

FIG. 4 is a schematic process diagram for verifying an analysis according to a user's request;

FIG. 5 is a schematic process diagram for verifying an analysis according to a predetermined schedule; and

FIG. 6 is a flowchart detailing a method according to one aspect of the invention.

### DETAILED DESCRIPTION

The present invention provides a system that uses an analysis credential and a method for using the analysis credential to analyze data in a user's mobile wallet. The credential, which is visible to the user in the user's wallet and can be removed by the user should they choose, is delivered to the user's device after receiving consent from the user. The analysis credential, once received and properly authorized, as will be further described below, causes the execution of instructions that gather statistical data based on at least a subset of the contents of the user's digital wallet.

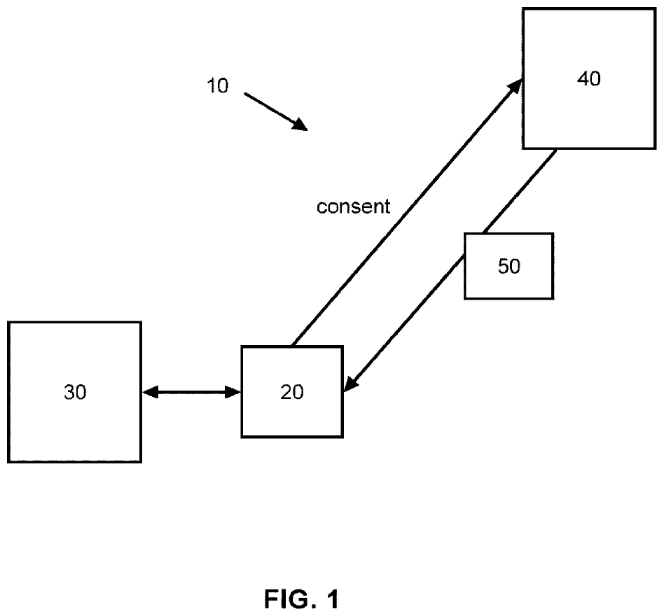

Referring now to FIG. 1, a schematic of a system 10 according to one aspect of the invention is shown. A user of a computing device 20, which comprises a wallet application 30, is prompted to provide consent to a delivery device 40. Once that consent is received, the analysis credential 50 is delivered to the computing device 20 and stored in the wallet application 30.

Of course, as should be understood, although FIG. 1 depicts a smartphone as the computing device 20, any suitable computing device 20 is possible. That is, the computing device 20 can be any device capable of supporting a desired mobile wallet application, including without limitation a mobile computing device, such as a smartphone, tablet, laptop, personal digital assistant (PDA), etc., or can be a stationary device such as a desktop computer, etc.

Further, any suitable mobile wallet can be used as the wallet application 30. Known applications based on frameworks such as the Hyperledger INDY™ SDK and the Azure™ Mobile Wallet SDK are suitable for the wallet application 30 of the present system. Additionally, proprietary mobile wallets, including other digital identity wallets, may be used depending on the implementation.

Mobile wallet credentials are well-known in the art and can be issued by numerous organizations, including private-and public-sector organizations. In general terms, a mobile wallet credential is an authenticated, cryptographically secured record of an attribute or transaction, typically stored on and/or verified against a digital and/or distributed ledger.

The delivery device 40 is any device suitable for receiving a user's consent to the analysis credential 50 and for delivering the analysis credential 50 to the computing device 20. For example, the delivery device 40 is, in some embodiments, a point-of-sale device, tablet, or similar device in communication with a server authorized to issue the analysis credential 50. The delivery device 40, in other embodiments, is a stand-alone authorized kiosk or computer terminal. As should be understood, the prompt for consent can be delivered as a popup notification on the computing device 20, as an email, SMS, or telephone/cellular call, etc. In other implementations, further, the consent may be received by the delivery device 40 without an explicit prompt to user. For example, if the user scans a QR code with the computing device 20 to obtain the analysis credential 50, the scanning process would qualify as a consent step. Other similar methods (e.g., Near-Field Communication (NFC), Bluetooth transmission, etc.) can be used to obtain consent. In general, the first consent step requires an active step on the part of the user, either taking a physical action with the computing device 20, or explicitly agreeing to the analysis credential 50 on receipt of a prompt to do so. Upon receiving the user's consent in whatever manner applies in a specific implementation, the delivery device 40 delivers the analysis credential 50 to the computing device 20.

Additionally, as will be described further below, the delivery device 40 is, in some implementations, also a verification device. That is, in some implementations, a single device is used both to deliver and verify the analysis credential 50 (e.g., where the issuer of the credential is also its verifier). However, in other implementations, separate devices perform these steps.

This analysis credential 50 is a credential designed to analyze other credentials (i.e., other contents of the user's wallet application 30). Specifically, the analysis credential 50 is a structured data packet that contains an indication of a search to be performed on the wallet contents and an indication of a value to be determined and which may be used for verifying the credential. In some embodiments, the analysis credential 50 directly comprises instructions for searching the wallet application 30 for items that satisfy at least one criterion. When an item is found that satisfies the at least one criterion, the item is added to a reviewable subset of the wallet contents. In other embodiments, the analysis credential 50 comprises information on the at least one criterion, but the specific instructions to be executed to perform the search may be embedded in the wallet application 30 itself, rather than contained in the analysis credential 50.

The specific items found in each search depend on the indications in the analysis credential 50, which are predetermined by the issuer of the analysis credential 50. As one non-limiting example, a search may look for all purchase receipts from a specific store within a specific time frame. As another non-limiting example, the search may look for all vaccination records contained in the wallet. As would be understood, the types of searches that any issuer can design would depend on what information is publicly available or available to them, as well as on the degree of standardization of particular record formats.

When the search of the wallet contents is complete, further instructions contained in the analysis credential 50 cause the evaluation of mathematical functions across the reviewable subset, focused on a predetermined parameter. For example, the parameter may be an ‘Amount Spent’ and the function may be a maximum-finding function. In such an example, any record containing an ‘Amount Spent’ would be added to the subset, and the records are then evaluated to determine the maximum ‘Amount Spent’.

In other embodiments, the evaluation functions may be performed during or simultaneously with the search of wallet contents. As a non-limiting example, to identify the maximum value of a specific parameter, a process similar to a Bubble Search algorithm may be executed. For this example, a comparison may be run each time a new item is found that uses that parameter. If the value of that parameter for the new item is higher than the current ‘maximum’ value, the current maximum value would be replaced with the new value. If the value of that parameter for the new item is lower than the current ‘maximum’ value, however, the new value would be ignored. In such an implementation, ‘item values’ are determined for each item as that item is found in the wallet application 30 (the ‘item value’ being the value of the parameter(s) of interest). In other implementations, item values are determined after all items that satisfy the at least one criterion are found.

The evaluation functions can include, without limitation, statistics-gathering functions such as: a count of the number of items having the parameter; a sum of the value of the parameter; an average value of the parameter; a minimum-determining function; a maximum-determining function; a function for determining a variance of the parameter; and a function to determine a standard deviation of the parameter. Of course, the implementation of these functions may depend on the parameter itself. For example, if the parameter is a numerical parameter such as an amount spent, the implementation of each function above may be trivial. If the parameter is a non-numerical parameter, however, based on non-numerical data such as demographic information, addresses, etc., the implementation of the function(s) may require that the data be preprocessed before the function(s) can be evaluated. Additionally, of course, other functions that do not require numerical or statistical analysis can also be implemented, depending on the embodiment. As one non-limiting example, a function in some implementations may be executed to gather non-numerical attribute values into a list or object structure. The suitable and/or desired function(s) can be determined by the issuer of the analysis credential 50.

Additionally, in some embodiments, the results of the evaluation function(s) may be passed to functions that are derived from machine-learning-based models. For example, if the analysis credential 50 is intended to identify a suitable market segment for the user, results of the analysis of the contents of the wallet application 30 could be fed to a predictive function derived from a machine-learning model. The prediction would then be based not only on the wallet contents but also on the previous data and analyses performed by the model. Of course, for privacy, such machine-learning-based analysis would also occur on the computing device 20. As such, this approach may not be suitable for all devices, particularly for those with comparatively lower processing power. Should data leave the computing device 20 for processing, however, the user is, preferably, informed of this step and provided with the opportunity to consent or refuse. Note that, at present, the degree to which users are prompted for consent is dependent on the implementation of the particular wallet application 30 used by the user. As well, the number of specific prompts for consent to various steps may be controllable by the user. That is, in some implementations, the user may be enabled to provide a blanket consent in advance, to reduce the number of specific consent prompts received. In other implementations, consent prompts cover multiple distinct steps and/or collections and/or analyses. Additionally, the user's computed data may be later added to the machine-learning model(s) and/or passed to an external device to form part of the data pool used by the machine-learning model(s). However, again, the user is preferably informed of this step and provided with the opportunity to consent or refuse.

Additionally, in some embodiments, an additional consent step is required of the user before any instructions relating to the analysis credential 50 are executed (i.e., before wallet contents are searched and/or analysed). This execution consent may be provided as a blanket consent in advance or may be requested each time the instructions relating to the analysis credential 50 are executed. Additionally, in some embodiments, the first consent (the consent to the delivery of the credential) may also provide execution consent. For example, where a user obtains an analysis credential 50 to be immediately verified, a single active provision of consent by the user may suffice for both delivery consent and execution consent.

The analysis credential 50 then preferably contains additional anonymizing instructions for the computed value. Using the ‘Amount Spent’ example above, again without limiting the scope of the invention in any way, instructions comprised in the analysis credential 50 would preferably evaluate the computed value against a expected value to prove whether or not a given statement is true. For example, an approach such as a Zero-Knowledge Proof (ZKP) may be used. Such a proof allows one party to prove to another party that a specific statement is true, without revealing any other information.

For example, if the analysis credential 50 was specifically to analyze whether a customer spent more than $100 (i.e., the ‘statement to be proved’ is “Amount Spent>$100”) at a particular store within a predetermined time period, the total ‘Amount Spent’ of receipts from that store and time period would be computed. Then, the statement to be proved could be evaluated as follows:
if Amount Spent>$100 return Yes
if Amount Spent≤$100 return No

The ‘proof value’ is thus ‘YES’ or ‘NO’. Of course, the ‘YES’ and ‘NO’ values may be a Boolean true/false variable, a binary numerical value, etc. This proof value could then be sent to a verifier and/or verification device, without exposing significant personal or sensitive data of the user to the verifier. That is, the analysis credential, when designed by the issuer, would comprise at least one expected value for the proof. In the above example, the ‘expected value’ for the credential could be either ‘YES’ or ‘NO’. When the verifier receives a proof value from the computing device, the verifier would compare that proof value with the expected value to determine whether the values match. When the proof value and the expected value match, the proof can be considered ‘satisfied’ and the credential is considered ‘valid’. When the proof value and the expected value match, the proof can be considered ‘unsatisfied’ and the credential is considered ‘invalid’. As can be seen, the verifier in the example above would not know or need to know the total amount spent, the name of the spender, when that amount was spent, what that amount was spent on, or any information other than the proof value in order to determine whether a specific wallet contains a valid credential. All they know and need to know is whether the proof condition of ‘Amount Spent>$100’ was satisfied.

In some embodiments, of course, additional information may be supplied to the verifier. In such embodiments, once statistical data has been based on the contents of the wallet application 30, this statistical data can be sent to the verifier and/or issuer of the analysis credential without intermediate anonymizing steps.

Further, depending on the granularity of the analysis credential 50, knowledge that the proof condition is or is not satisfied could be sufficient to uniquely identify the user. However, the user preferably is made aware of such additional data on receiving the credential and is provided with the ability to or the option to remove the credential from the wallet application 30 should they wish.

Further, in some embodiments, the user is specifically asked for a second consent (i.e., “verification consent”) before the proof value is sent to a verifier. The prompt for verification consent preferably includes a clear indication of what information is being sent to the verifier and an indication of what the verifier intends to do with that information (e.g., at least the value to be sent).

The verifier then verifies the credential (i.e., compares the value received from the computing device 20 to an expected value, as described above). Verification determines whether a credential in a wallet is valid. When a credential is valid, a specific action is undertaken. When a credential is not valid (i.e., the expected value and the received value do not match), a different specific action is undertaken.

In some implementations, the verifier may have all the necessary information to verify the credential without contact with other parties (e.g., the credential's issuer). As one non-limiting example, if the verifier of a credential is also the issuer of the credential, they would have direct access to the ledger records and/or any other cryptographic tools needed to verify the credential. In other implementations, the verifier may need to communicate with the issuer, access a ledger operated by the issuer, etc. to determine the expected value for the credential and determine whether the credential is satisfied. If the credential is valid (i.e., the received value matches the expected value), a first result is passed to the computing device 20. The first result is determined by the issuer and can have any desired effect. As non-limiting examples, the first result could include: a specific coupon or credential is to be stored in the user's wallet application 30, a prompt to open a specific Web site, a passcode or discount code, an access code for a physical location, etc. If the credential is not satisfied, a different result is passed to the computing device 20. The second result may be a message, a notification, a prompt to open a different specific Web site, a different coupon, credential, passcode, discount code, etc., as initially determined by the issuer.

In some embodiments, the wallet application 30 also stores previously computed values for the analysis credential 50. That is, in some embodiments, the most recently computed value evaluated for any analysis credential 50 is retained. In other embodiments, a full history of computed values is stored in the wallet application 30. Embodiments with such storage capabilities (either of the most recently computed value or of all previously computed values) are suitable for use with analysis credentials 50 that are to be run on a predetermined schedule.

That is, in some embodiments, the instructions relating to the analysis credential 50 are executed at predetermined intervals, e.g., once a week, once a month, etc., and/or at a predetermined time (e.g., at noon on a specific date). As should be understood, such prescheduled/‘background’ instructions may not be practical or suitable for use with all systems. As an example, such embodiments may be difficult to implement on current versions of the iOS™ operating system. However, of course, such implementations may be well-suited to implementation on other operating systems or versions thereof. The person skilled in the art would understand how to adapt such scheduled embodiments to the desired technical environment. In such embodiments, when a request is made to verify the analysis credential 50, the value does not need to be recomputed. Instead, the computing device 20 would simply provide the most recently computed value for the analysis credential 50 to the verifier. In other embodiments, the instructions are only executed at the specific request of the user (i.e., as part of a request to verify the analysis credential 50). These request-only analysis credentials 50 may also be referred to as ‘on-proof credentials’, i.e., evaluated on request for proof. Of course, a single wallet application 30 can contain both scheduled analysis credentials 50 and non-scheduled (request-only) analysis credentials 50 at any time, depending on the implementation and the user's choices.

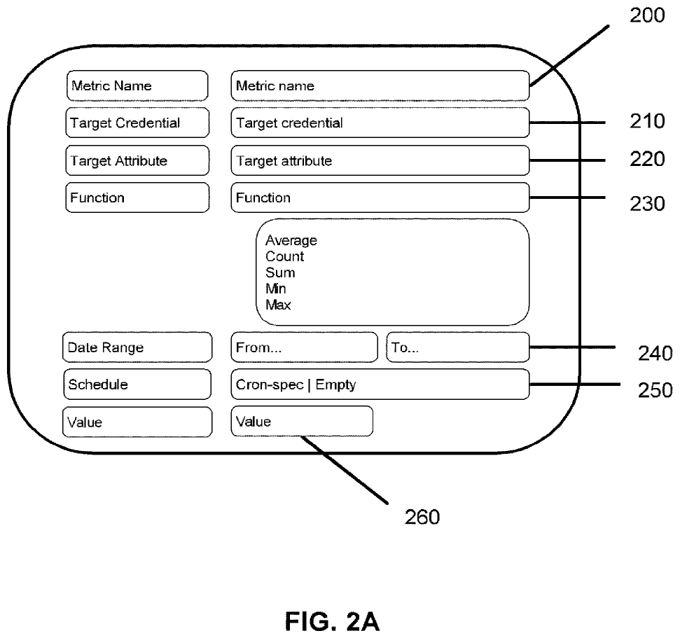

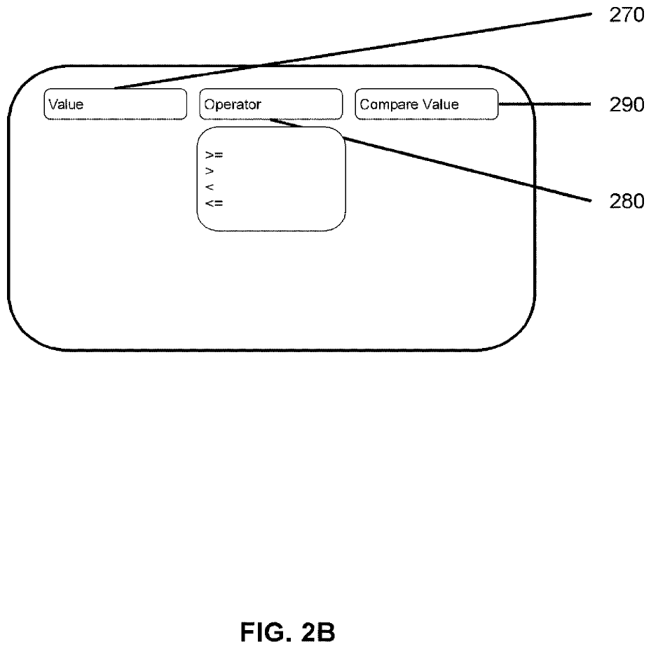

Additionally, in some embodiments, the instructions relating to the analysis credential 50 comprise a machine-learning-trained model (i.e., a predictive function that has been trained using a neural network or other machine-learning-based training framework). The model is, in some implementations, implemented and trained on an external server. The external server preferably has access to large amounts of data for training the model (i.e., refining the predictive function). When the analysis credential 50 is delivered to the wallet application 30, the analysis credential in such implementations would be delivered with the latest version of the model, representing the latest training. That is, in such implementations, the instructions would comprise the predictive function along with any coefficients, parameters, hyperparameters, etc., to be input to the function. Executing the instructions would then comprise running the predictive function with suitable inputs, including, without limitation, such coefficients, parameters, hyperparameters, etc., and the contents of the wallet application 30. Further, in some implementations, the computing device 20 communicates with the external server on a regular and/or prescheduled basis to obtain updated versions of the model (if and/or as available). User consent is preferably requested for each such update. In other implementations, such as request-only verification implementations, an updated version of the model is only obtained from the external server when a new request to verify the credential is made. In still further implementations, of course, updated versions of the model are not received at any point (e.g., for credentials that are only executed once). FIG. 2A is a schematic of an exemplary interface for use in applications that create an analysis credential 50 (i.e., of an interface visible to an issuer when designing the analysis credential 50). Nothing in this interface should be considered to limit the scope of the invention in any way and many different fields could be used, as desired or as suitable for a given implementation. However, the various fields depicted in FIG. 2A can be described as follows:
The ‘Metric Name’ field 200 is a title field for providing a title designation of the analysis credential 50.
The ‘Target Credential’ field 210 allows the issuer to identify which types and/or which specific credentials should be searched. For example, if the issuer is a private company (“Company A”), they would have access to any public wallet contents and to any wallet contents they specifically provided to the user (e.g., other credentials, receipts, cards, etc.). However, Company A should not be able to review wallet contents provided by other private issuers (e.g., “Company B”, “Company C”, etc.) or wallet contents containing sensitive information (e.g., the user's health information), unless the user has agreed to make such information available to Company A.
The ‘Target attribute’ field 220 determines which parameter(s) to evaluate (e.g., ‘Amount Spent’). Depending on the implementation, multiple parameters may be simultaneously evaluated.
The ‘Function’ field 230 determines which evaluation functions to apply to the results of the search. As can be seen, in this interface, options including Average, Count, Sum, Min, and Max are available. However, as described above, many different functions, including machine-learning-based functions, may be applied depending on the implementation.
The ‘Date Range’ function allows the issuer to determine a time period within which the parameter should be assessed (e.g., amount spent in a month or in a year). In some implementations, specific dates are selected, e.g., Jan. 1, 2019 to Dec. 21, 2019. In other implementations, a relative time period is selected, such as “the last 30 days” or “the last year”. Relative time periods are particularly useful where the analysis credential 50 is to be evaluated on a predetermined schedule and/or where changes in the computed value over time are of interest.
The ‘Schedule’ field 250 allows the issuer to set a predetermined schedule for executing the instructions relating to the analysis credential 50, as described above. This field may be left empty, set to ‘null’, etc. for request-only analysis credentials 50.
The ‘Value’ field 260 is for setting an expected value for the analysis credential 50. In some implementations, multiple values may be assigned to a single analysis credential 50 (e.g., where multiple parameters are simultaneously assessed).

FIG. 2B is a schematic of another exemplary interface for applications that create the analysis credential 50 of FIG. 2A. In this FIG. 2B, the ‘Value’ field 270 contains the expected value from FIG. 2A and is preferably auto-populated when the issuer is designing the credential. The ‘Operator’ field 280 allows the issuer to select a comparison operator for the proof of the analysis credential 50. Again, although this interface only shows numeric operators ≥, >, <, and ≤, any suitable operators, including Boolean operators and other operators, may be used. Additionally, in some implementations, multiple values may be assessed in a single proof. The ‘Compare Value’ field 290 represents the value received from the computing device 20 (and is given a variable name in this interface). Again, nothing in this interface image should be considered to limit the scope of the invention in any way.

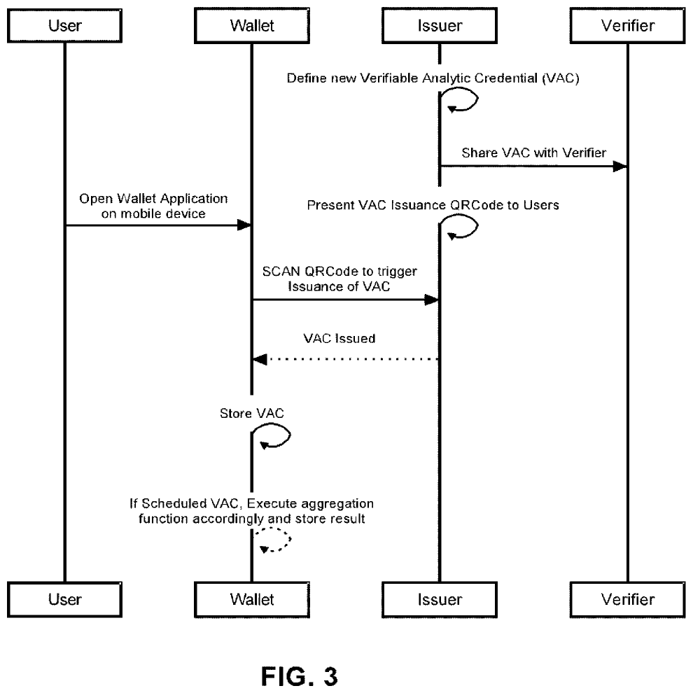

FIG. 3 is a sequence diagram for a process for delivering an analysis credential according to an embodiment of the invention. As can be seen, the process begins with the issuer defining/designing an analysis credential and then sharing that analysis credential with an issuer. On receiving a request from a user (as depicted, by scanning a QR code in this exemplary implementation), the issuer issues the analysis credential to the user's wallet.

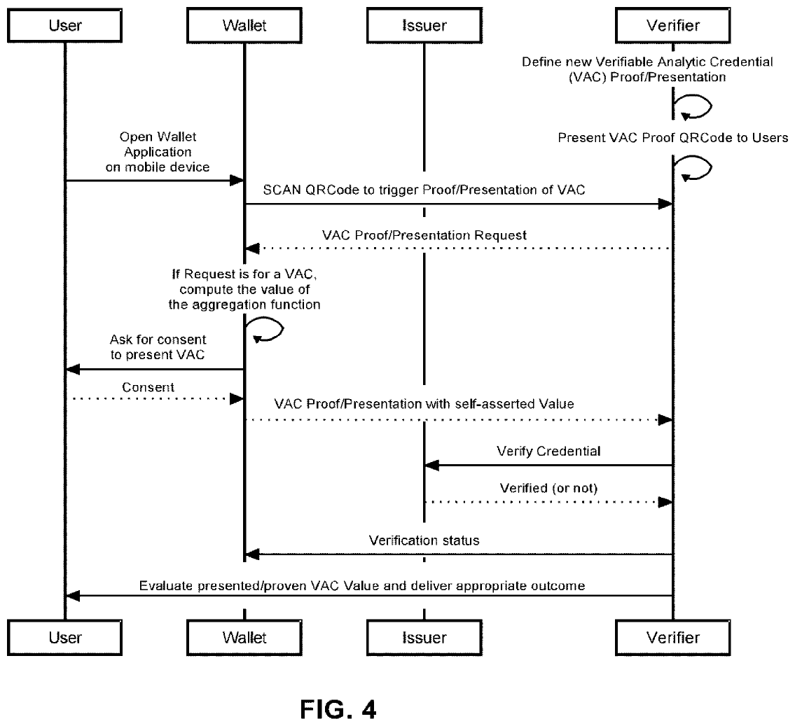

FIG. 4 is a sequence diagram for a process for request-only verification of an analysis credential according to an embodiment of the invention. The analysis credential is delivered as in FIG. 3. Then, the instructions relating to the analysis credential are executed and the user is prompted to provide consent to share the computed value with the verifier. The verification is returned to the wallet and an outcome (i.e., a first result or second result) is provided to the user.

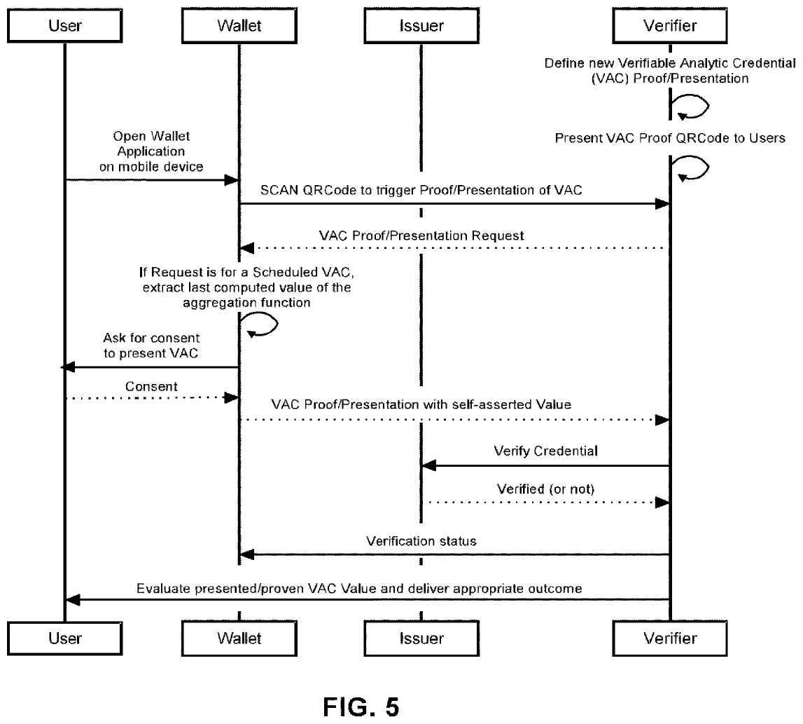

FIG. 5 is a sequence diagram for a process for verification of an analysis credential according to an embodiment of the invention in which the instructions are executed on a pre-determined schedule. As shown, in this exemplary implementation, when the user requests the analysis credential be verified, the most recently computed value for the analysis credential is used. That is, the value for the analysis credential is not re-evaluated each time a verification request is made.

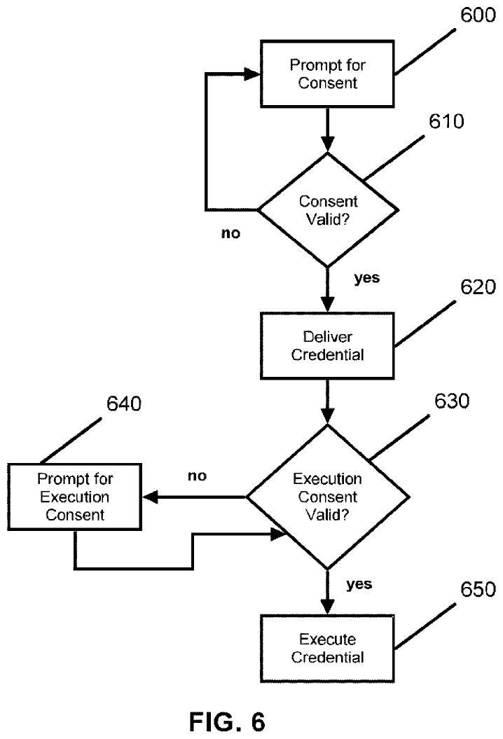

FIG. 6 is a flowchart detailing a method according to an aspect of the invention. At step 600, the user is prompted to provide consent, either through their device or through a real-world interaction (such as scanning a QR code, etc.). If valid consent is not received at step 610, the user is prompted again at step 600. When valid consent is received at step 610, the analysis credential is delivered to the device. In the embodiment shown, the method determines at step 630 whether valid execution consent (i.e., the user's consent to execute instructions relating to the analysis credential) has been provided. If not, the user is prompted to provide execution consent at step 640, until valid consent is provided. At step 650, the credential is run (i.e., the instructions are executed).

As used herein, the expression “at least one of [x] and [y]” means and should be construed as meaning “[x], [y], or both [x] and [y]”.

It should be clear that the various aspects of the present invention may be implemented as software modules in an overall software system. As such, the present invention may thus take the form of computer executable instructions that, when executed, implements various software modules with predefined functions.

Embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for analyzing mobile wallet contents, the method comprising the steps of:
receiving a prompt for consent to deliver an analysis credential to a mobile wallet, said mobile wallet containing a plurality of items;
receiving said consent from a user of said mobile wallet;
after said consent is received, receiving said analysis credential at said mobile wallet; and
executing instructions relating to said analysis credential to thereby determine a value for said analysis credential, said value being based on at least a subset of said plurality of items,
wherein said mobile wallet is operated on a computing device used by said user.

2. The method according to claim 1, further comprising the step of providing said value to a verifier of said analysis credential for verification.

3. The method according to claim 2, wherein a second consent is requested from said user before providing said value to said verifier.

4. The method according to claim 1, wherein said consent is received by way of a specific physical action of said user.

5. The method according to claim 1, wherein executing said instructions comprises:
searching said mobile wallet for items that meet at least one criterion, said at least one criterion being described in said analysis credential;
when an item is determined to meet said at least one criterion, said item is added to said subset; and
computing an item value for each item in said subset, based on instructions in said analysis credential.

6. The method according to claim 5, wherein said value is based on item values for all items in the subset.

7. The method according to claim 1, wherein said instructions are comprised in at least one of: said analysis credential and an application relating to said mobile wallet.

8. The method according to claim 1, wherein said value is a numerical value.

9. The method according to claim 5, wherein said value is determined by applying at least one function to said item values.

10. The method according to claim 9, wherein said at least one function comprises at least one of:
a count;
a sum;
an average;
a minimum-determining function;
a maximum-determining function;
a variance-determining function; and
a standard deviation function.

11. The method according to claim 2, wherein, based on said value, said verifier determines whether said analysis credential is satisfied.

12. The method according to claim 11, wherein, when said analysis credential is satisfied, said verifier provides a first result to said computing device and, when said analysis credential is unsatisfied, said verifier provides a second result to said computing device.

13. The method according to claim 1, wherein said value is determined at at least one of: a prescheduled time and predetermined intervals.

14. The method according to claim 1, wherein said value is determined responsive to a request by said user.

15. The method according to claim 2, wherein said verifier determines whether said analysis credential is satisfied based on communication with an issuer of said analysis credential.

16. The method according to claim 1, wherein said value is unassociated with personally identifiable information of said user.

17. A credential for a mobile wallet used by a user, said credential being a data file for analyzing contents of said mobile wallet and said credential comprising an expected value, wherein said credential is visible to said user wherein consent of said user is required for any analysis, and wherein said contents are analyzed to thereby produce a value for said credential, said value being for comparison with said expected value.

18. The credential according to claim 17, wherein said data file comprises at least one of: instructions for analyzing said contents, and other instructions to direct said mobile wallet to analyze said contents.

19. The credential according to claim 17, wherein said instructions are only executed after a valid request from said user.

20. The credential according to claim 17, wherein, when said value is computed, said user is automatically prompted to provide consent for sending said value to a verifier of said credential, and, when said consent is received, said value is automatically sent to said verifier.
